(19) United States
(12) Patent Application Publication
(10) Pub. No.: US 2026/0058838 A1
(43) Pub. Date: Feb. 26, 2026

(54) SYSTEM, NON-TRANSITORY COMPUTER-READABLE STORAGE MEDIUM, AND METHOD

(71) Applicant: NINTENDO CO., LTD., Kyoto-shi (JP)

(72) Inventors: Atsuya IWAHASHI, Kyoto-shi (JP); Ryota OIWA, Kyoto-shi (JP); Sumikazu ONO, Kyoto-shi (JP)

(21) Appl. No.: 19/289,551

(22) Filed: Aug. 4, 2025

(30) Foreign Application Priority Data
Aug. 20, 2024 (JP) 2024-139005

(51) Int. Cl. H04L 12/18

(52) U.S. Cl. CPC H04L 12/1822

(57) ABSTRACT

A chat execution unit configured to cause terminals used by a plurality of respective accounts that participate in one room to perform a voice chat, a setting unit configured to set, based on an operation by a user of a first account, one or more accounts in friend relation with the first account as first-state accounts for the first account, a determination unit configured to determine whether or not a predetermined condition is satisfied when an invitation operation to invite the first account to a room is performed by a user of a second account, the predetermined condition including a condition that at least one of the first-state accounts for the first account is not participating in the room, and a notification unit configured to cause a terminal used by the first account to notify that the first account is invited to the room when the predetermined condition is satisfied.

This non-provisional application is based on Japanese Patent Application No. 2024-139005 filed with the Japan Patent Office on August 20, 2024, the entire contents of which are hereby incorporated by reference.

### FIELD

The present disclosure relates to a system, a non-transitory computer-readable storage medium, and a method.

### BACKGROUND AND SUMMARY

A technique to allow a certain user to open a virtual room on a server and thereafter to invite another user to the virtual room to enjoy conversation has been known.

A user invited to a virtual room may unintentionally participate in the virtual room in which the user does not desire to participate.

(Configuration 1) An exemplary embodiment provides a system that includes a chat execution unit configured to perform a voice chat between terminals used by a plurality of respective accounts that participate in one room, a setting unit configured to set, based on an operation by a user of a first account, one or more accounts in friend relation with the first account as first-state accounts for the first account, a determination unit configured to determine whether a predetermined condition is satisfied when an invitation operation to invite the first account to a room is performed by a user of a second account, the predetermined condition including a condition that at least one of the first-state accounts for the first account is not participating in the room, and a notification unit configured to cause a terminal used by the first account to notify that the first account is invited to the room when the predetermined condition is satisfied.

(Configuration 2) In Configuration 1, the terminal used by the first account shows a room that satisfies the predetermined condition, in a room list where at least one room to which the first account is invited by another account is shown in a list.

(Configuration 3) In Configuration 2, the terminal used by the first account obtains information on the room to which the first account is invited, and shows in the room list, the room that satisfies the predetermined condition among at least one room corresponding to the obtained information.

(Configuration 4) In Configuration 2 or 3, the terminal used by the first account shows a room not satisfying the predetermined condition, when the terminal accepts a predetermined operation from the user of the first account while the room list is shown.

(Configuration 5) In Configuration 2, the terminal used by the first account obtains information on a room that satisfies the predetermined condition, shows information that satisfies the predetermined condition, in the room list, obtains information on a room that does not satisfy the predetermined condition when the terminal accepts a predetermined operation from the user of the first account, and shows information that does not satisfy the predetermined condition, in the room list.

(Configuration 6) In Configuration 1, the terminal used by the first account obtains information indicating an invitation to a chat when the predetermined condition is satisfied.

(Configuration 7) In any of Configurations 1 to 6, the predetermined condition includes a condition that a blocked account for the first account is not participating in the room.

(Configuration 8) In any of Configurations 1 to 7, the setting unit sets a third account as the first-state account for the first account, when the third account approves a friend application to be in the friend relation, in accordance with an advance setting operation in transmission of the friend application by the first account to the third account.

(Configuration 9) In any of Configurations 1 to 8, the setting unit sets, among the one or more accounts in the friend relation with the first account, an account different from the first-state account as a second-state account shown as a candidate for an account to be invited by the first account to the room, based on an operation by the user of the first account.

(Configuration 10) In Configuration 9, the setting unit causes the user to select an account to be the second-state account from among the one or more accounts in the friend relation and sets an account that has not been selected as the first-state account.

(Configuration 11) In Configuration 9, the notification unit notifies, when the predetermined condition is satisfied, the user that the first account is invited to the room independently of whether a friend that is neither of the first-state account and the second-state account for the first account is participating in the room.

(Configuration 12) In any of Configurations 1 to 11, the predetermined condition includes a condition that the first-state account is not scheduled to participate.

(Configuration 13) Another exemplary embodiment provides a program to be used in a system including a server including one or more processors and a plurality of terminals managed by the server, the program causing the one or more processors to perform operations including performing a voice chat between terminals used by a plurality of respective accounts that participate in one room, setting, based on an operation by a user of a first account, one or more accounts in friend relation with the first account as first-state accounts for the first account, determining whether a predetermined condition is satisfied when an invitation operation to invite the first account to a room is performed by a user of a second account, the predetermined condition including a condition that at least one of the first-state accounts for the first account is not participating in the room, and causing a terminal used by the first account to notify that the first account is invited to the room when the predetermined condition is satisfied.

(Configuration 14) Another exemplary embodiment provides a method to be used in a system including a server including one or more processors and a plurality of terminals managed by the server, the method causing at least one of the plurality of terminals to perform a voice chat between terminals used by a plurality of respective accounts that participate in one room, set, based on an operation by a user of a first account, one or more accounts in friend relation with the first account as first-state accounts for the first account, determine whether a predetermined condition is satisfied when an invitation operation to invite the first account to a room is performed by a user of a second account, the predetermined condition including a condition that at least one of the first-state accounts for the first account is not participating in the room, and cause a terminal used by the first account to notify that the first account is invited to the room when the predetermined condition is satisfied.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 shows an exemplary illustrative non-limiting drawing illustrating an exemplary information processing system according to the present embodiment.

FIG. 2 shows an exemplary illustrative non-limiting drawing illustrating an exemplary hardware configuration of a server included in the information processing system according to the present embodiment.

FIG. 3 shows an exemplary illustrative non-limiting drawing illustrating an exemplary hardware configuration of a game terminal included in the information processing system according to the present embodiment.

FIG. 4 shows an exemplary illustrative non-limiting drawing illustrating an exemplary sequence diagram for illustrating processing for setting friend relation.

FIG. 5 shows an exemplary illustrative non-limiting drawing illustrating an exemplary flowchart showing processing at the time of start-up of a chat app.

FIG. 6 shows an exemplary illustrative non-limiting drawing illustrating an exemplary display screen in step S202.

FIG. 7 shows an exemplary illustrative non-limiting drawing illustrating a conceptual diagram of a status of a chat friend category.

FIG. 8 shows an exemplary illustrative non-limiting drawing illustrating an exemplary sequence diagram showing a flow of an overlay notification.

FIG. 9 shows an exemplary illustrative non-limiting drawing illustrating an exemplary flowchart for illustrating determination processing in step S301.

FIG. 10 shows an exemplary illustrative non-limiting drawing illustrating an exemplary display screen showing an exemplary overlay notification.

FIG. 11 shows an exemplary illustrative non-limiting drawing illustrating an exemplary main menu screen of the chat app.

FIG. 12 shows an exemplary illustrative non-limiting drawing illustrating an exemplary sequence diagram for showing a list of virtual rooms.

FIG. 13 shows an exemplary illustrative non-limiting drawing illustrating an exemplary display screen showing a list of shown rooms.

FIG. 14 shows an exemplary illustrative non-limiting drawing illustrating an exemplary display screen showing details of a virtual room to which an account is invited by an account B.

FIG. 15 shows an exemplary illustrative non-limiting drawing illustrating an exemplary display screen showing a list of not-shown rooms.

FIG. 16 shows an exemplary illustrative non-limiting drawing illustrating an exemplary display screen showing details of a virtual room to which an account is invited by an account C.

FIG. 17 shows an exemplary illustrative non-limiting drawing illustrating an exemplary display screen showing details of a virtual room to which an account is invited by an account D.

### DETAILED DESCRIPTION OF NON-LIMITING EXAMPLE EMBODIMENTS

The present embodiment will be described in detail with reference to the drawings. The same or corresponding elements in the drawings have the same reference characters allotted and description thereof will not be repeated.

### Embodiment

### [A. Overview]

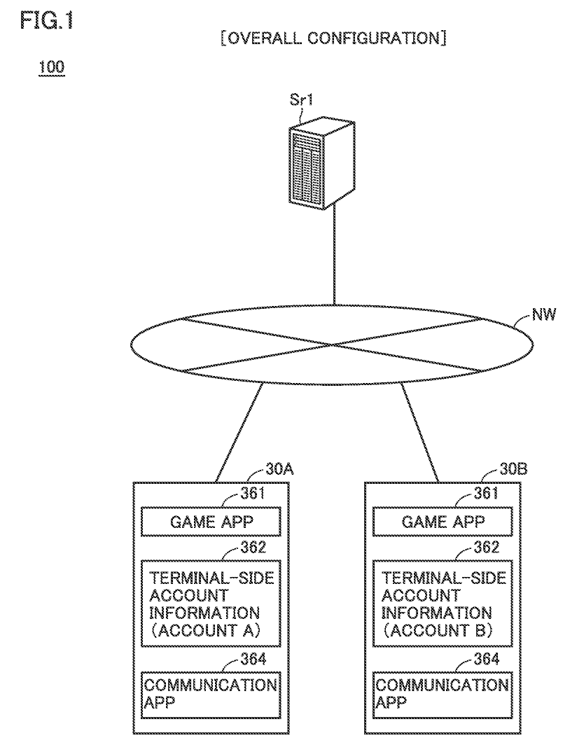

An exemplary configuration of an information processing system 100 according to the present embodiment will be described. Exemplary information processing system 100 according to the present embodiment will be described with reference to FIG. 1. Information processing system 100 is a system configured to provide a communication service between accounts with a server Sr1. The account is information for identification of a user. Information on all accounts generated in information processing system 100 may be stored in server Sr1.

In information processing system 100 in the present embodiment, a certain account can invite at least another account to communication. Though communication includes at least one of communication accompanied by voice and sound and communication by text, communication accompanied by voice and sound will mainly be described in the present embodiment.

Communication is realized by execution of a communication application program 364 stored in each terminal. Communication application program 364 is a program for executing a chat application (which is referred to as a "chat app").

A plurality of accounts that participate in the same communication group (which will be referred to as a "virtual room" below) can communicate with each other while a chat app is running. The chat app in the present embodiment can have users communicate while the chat app has one or more accounts perform distribution of a game in the virtual room. Communication by means of the chat app will simply be referred to as a "chat" below. In the chat app, distribution of the game does not have to be performed.

Communication between a game terminal associated with a certain account that participates in a certain virtual room and one or more other game terminals brought in correspondence with one or more other accounts that participate in the virtual room, respectively, may be enabled by satisfaction of a predetermined condition. Server Sr1 may perform at least a part of processing for determining whether or not the predetermined condition is satisfied.

The predetermined condition in communication between accounts is, for example, that friend relation has been set therebetween. The friend relation refers to relationship that allows a predetermined function to be provided to two accounts. The user inputs a friend code or the like of a specific account desired to be set as a friend thereof, to the user's terminal to apply to the specific account for friend relation. In the virtual room, each account should only be in friend relation with at least another account, and does not have to be in friend relation with all other accounts.

The predetermined function provided as a result of setting of friend relation may include, for example, a function to show information on a friend (an on-line status of a friend, a game title being played by the friend, information indicating details and time and day of becoming a friend, or the like), to transmit an invitation to an on-line game, and to allow play of a game in the same team. The friend relation is relation that allows provision of a communication function and does not have to provide other functions.

In the present embodiment, friend relation indicates relationship which is bidirectional association of accounts with each other. For example, in an example where friend relation is set between accounts A and B, account A is a friend for account B and account B is also a friend for account A.

In the present embodiment, a user performs friend categorization in connection with a chat for each account with which an account of the user is in friend relation. In the present embodiment, a friend category in connection with the chat includes a first category and a second category. An account categorized to the first category (which will be referred to as a "first-category account" below) is, for example, a friend with which the user is not assumed to perform a chat. An account categorized to the second category (which will be referred to as a "second-category account" below) is, for example, a friend with which the user is assumed to perform a chat.

In the present embodiment, unlike the friend relation, the friend category in connection with the chat is unidirectionally stored. For example, even when account B is set as the second-category account for account A, account A may be set as the first-category account for account B or account A may not have set the friend category for account B.

In an example where a certain account gives an instruction to generate a virtual room and it invites a friend to the virtual room generated in accordance with the instruction, the certain account will be referred to as a "host account" below. The host account may be able to invite only the second-category account for the host account to the virtual room. Information processing system 100 in the present embodiment has only the second-category account for the host account shown to the host account as a candidate to be invited to the virtual room when the host account selects a friend to be invited to the virtual room.

An account invited to the virtual room by the host account may be referred to as an "invited account" below. The host account can invite a plurality of accounts as the invited accounts to one virtual room. In this case, when a certain account is invited to the virtual room as the invited account, another invited account invited to the virtual room is not necessarily the second-category account for the certain account. In other words, another invited account invited to the virtual room may be the first-category account for the certain account. Similarly, in an example where a certain account is invited to the virtual room as the invited account, the host account of the virtual room may also be the first-category account for the certain account.

In information processing system 100 in the present embodiment, a manner of notification to a certain invited account, about an invitation to the virtual room is varied between a case in which none of accounts that can participate in the virtual room is the first-category account for the certain invited account and a case in which at least one of all other accounts that can participate in the virtual room is the first-category account for the certain invited account. The "accounts that can participate in the virtual room" in the present embodiment include the host account that has generated the virtual room and all accounts invited by the host account. Can participate in encompasses not only being participating in the virtual room but also having been invited but not yet having participated or having left after participation. In the present embodiment, an account that left the virtual room can again participate in the virtual room.

### [B. Overall Configuration]

Information processing system 100 may include server Sr1 and a plurality of terminals such as several ten, several hundred, or more terminals. The plurality of terminals may include a dedicated game terminal, a smartphone, a tablet, a PC, and the like. The plurality of terminals and server Sr1 included in information processing system 100 are connectable to one another over a network NW. Network NW is, for example, the Internet. In the example in FIG. 1, among the plurality of terminals included in information processing system 100, game terminals 30A and 30Bare illustrated.

Game terminals 30A and 30B are information processing apparatuses dedicated for a game for providing a game to a user by way of example. Game terminals 30A and 30B are collectively referred to as a "game terminal 30" below. Each of game terminals 30A and 30B includes a game application program 361, terminal-side account information 362, and communication application program 364. Game application program 361 is a program for executing a game application. Game terminal 30 may be a portable game terminal, a stationary game terminal, or a hybrid of the former. Game terminal 30 may be a general-purpose PC, a smartphone, a tablet, or the like configured to execute a game application program.

Terminal-side account information 362 includes information on an individual account associated with game terminal 30. Accounts A and B are associated with game terminals 30A and 30B, respectively. Therefore, as shown in FIG. 1, terminal-side account information 362 included in game terminal 30A and terminal-side account information 362 included in game terminal 30B include information on account A and information on account B, respectively. Communication application program 364 is a program for transmission/reception of voice and sound between users in the virtual room. Accounts A and B can chat with each other by executing communication application program 364 while each of them executes game application program 361.

A plurality of accounts may be associated with game terminal 30. In other words, terminal-side account information 362 may include information on a plurality of accounts. The same account may be associated with a plurality of terminals.

### [C. Exemplary Hardware Configuration]

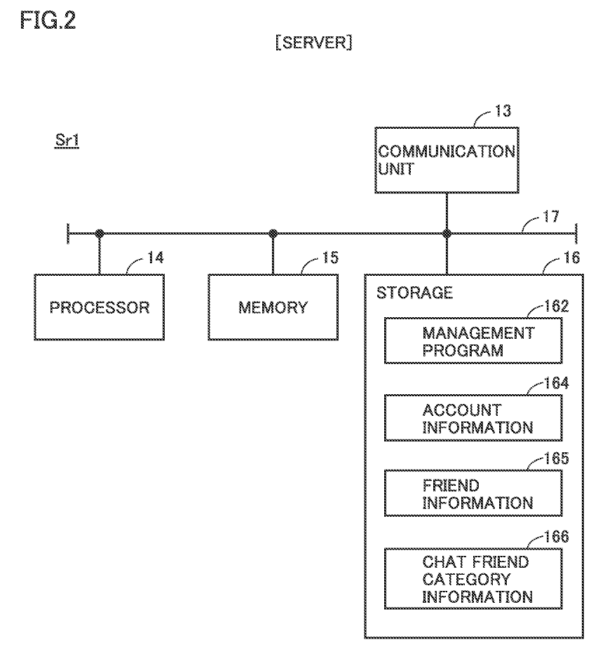

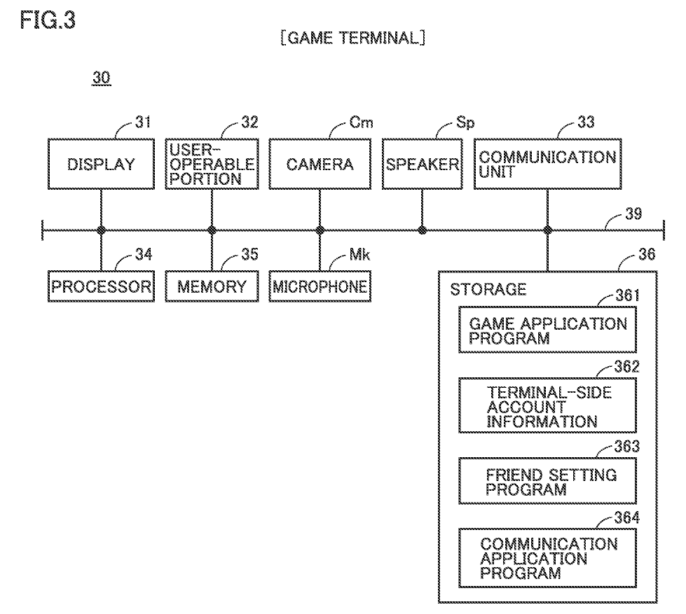

An exemplary hardware configuration of server Sr1 and game terminal 30 included in information processing system 100 according to the present embodiment will be described below with reference to FIGS. 2 and 3.

An exemplary hardware configuration of server Sr1 included in information processing system 100 according to the present embodiment will be described with reference to FIG. 2. Referring to FIG. 2, server Sr1 includes a communication unit 13, one or more processors 14, a memory 15, and a storage 16. These components are connected to communicate data with one another through a bus 17. Server Sr1 may be a dedicated information processing apparatus configured to manage an account and to perform communication, or may be implemented by a general-purpose server.

Communication unit 13 communicates with a plurality of terminals included in information processing system 100 over network NW. Communication unit 13 is provided with at least one of hardware necessary for wired communication and hardware necessary for wireless communication. The entirety or a part of processing by communication unit 13 may be performed by processor 14.

Processor 14 is a processing entity (processing means) for performing processing provided by server Sr1. The term "processor" in the present disclosure means processing circuitry such as a central processing unit (CPU), a micro processing unit (MPU), or a graphics processing unit (GPU). The term "processor" encompasses processing circuitry that performs processing in accordance with instruction codes described in a program, processing circuitry in which a plurality of functions are integrated, such as a system on chip (SoC), hard-wired circuitry, and the like.

Memory 15 is a volatile storage device (storage medium) accessible by processor 14, and for example, a dynamic random access memory (DRAM), a static random access memory (SRAM), or the like may be employed as memory 15. Storage 16 is a non-volatile storage device (storage medium) accessible by processor 14, and for example, a hard disk, a flash memory, or the like may be employed as storage 16. Storage 16 may be, for example, a storage medium attachable to and removable from server Sr1, such as an optical disc and a cartridge.

A management program 162, account information 164, friend information 165, and chat friend category information 166 are stored in storage 16. Processor 14 reads management program 162 and develops and executes the same on memory 15. The term "memory" herein encompasses at least both of a volatile memory and a non-volatile storage.

Management program 162 is a program that causes game terminals 30 used by a plurality of respective accounts that participate in one room to perform a chat, and it is, for example, a program for controlling processing for performing communication between accounts, processing for giving a notification of an invitation to communication, and the like in a centralized manner. Account information 164 is information on all accounts registered in information processing system 100, and may include a name, an age, a mail address, an ID, a password, and the like of the user of each account.

Friend information 165 is information indicating which accounts among all registered accounts are in friend relation. Chat friend category information 166 is information indicating a friend category in connection with the chat described above (which will simply be referred to as a "chat friend category" below), and information indicating whether a friend of a certain account is set as the first-category account or the second-category account for the certain account or in a yet-to-be set state.

An exemplary hardware configuration of game terminal 30 included in information processing system 100 according to the present embodiment will be described with reference to FIG. 3. Game terminal 30 includes a display 31, a user-operable portion 32, a communication unit 33, one or more processors 34, a memory 35, a storage 36, a camera Cm, a microphone Mk, a speaker Sp, and a bus 39.

Display 31 shows an image generated as a result of information processing performed by processor 34. User-operable portion 32 accepts an operation by the user who operates game terminal 30. User-operable portion 32 may include, for example, at least one of a push button, an operation lever, a touch panel, a mouse, and a keyboard.

Components included in game terminal 30 are connected to communicate data with one another through bus 39. Game terminal 30 realizes communication between accounts through a voice chat, with the use of microphone Mk, camera Cm, and speaker Sp.

Such a component as display 31, user-operable portion 32, microphone Mk, camera Cm, or speaker Sp does not have to be included in game terminal 30. For example, at least one of display 31, user-operable portion 32, microphone Mk, camera Cm, and speaker Sp may be an external apparatus that is different from game terminal 30 and connectable to game terminal 30 through a wire or wirelessly.

A game application program 361, terminal-side account information 362, a friend setting program 363, and communication application program 364 are stored in storage 36.

Game application program 361 may be, for example, downloaded from a not-shown app distribution server over the network to game terminal 30 or read from a physically connected separate storage medium. Friend setting program 363 is a program for presenting an application for requesting another account to be in friend relation or for approving a request received from another account.

Communication application program 364 is an application for communication with a friend. Communication application program 364 includes overlay notification processing for superimposing reception of an invitation to the virtual room by the host account on a game execution screen, a screen for selection of a game title, or the like in response to reception of the invitation. The overlay notification may be shown superimposed on a shown screen, independently of contents of the shown screen.

### [D. Setting of Chat Friend Category]

In information processing system 100 in the present embodiment, when none of accounts that can participate in the virtual room to which the accounts are invited is the first-category account for the account on an invited side, game terminal 30 with which the account on the invited side is associated gives an overlay notification indicating the invitation to the virtual room. The overlay notification will be described below with reference to an example where account B serves as the host account and invites a plurality of invited accounts including account A.

Account A can set an account that has been set as a friend, as the first-category account or the second-category account. In the present embodiment, for setting by account A, of the chat friend category for a specific account, account A should be in friend relation with the specific account.

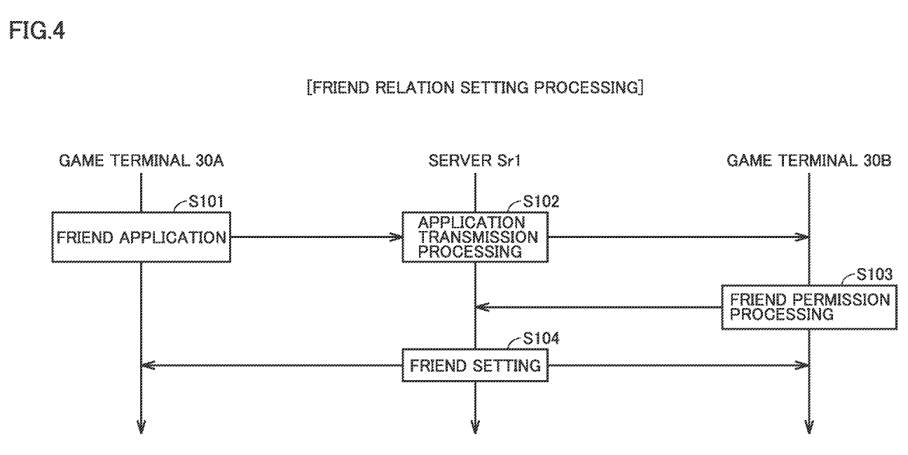

An example in which friend relation is set between accounts A and B will initially be described with reference to FIG. 4. An exemplary sequence diagram for illustrating processing for setting friend relation will be described with reference to FIG. 4. Game terminal 30A with which account A has been associated executes friend setting program 363 and issues to server Sr1, a friend application indicating desire to add account B as the friend (step S101).

Server Sr1 transmits the friend application from account A to game terminal 30B with which account B has been associated (step S102). Game terminal 30B transmits permission for the friend application to server Sr1 based on an operation by account B (step S103).

Upon receiving permission as the friend from account B, server Sr1 sets friend relation between accounts A and B (step S104). Specifically, server Sr1 adds information indicating friend relation between accounts A and B to friend information 165. In step S104, server Sr1 notifies each of game terminals 30A and 30B that friend relation has been set between accounts A and B.

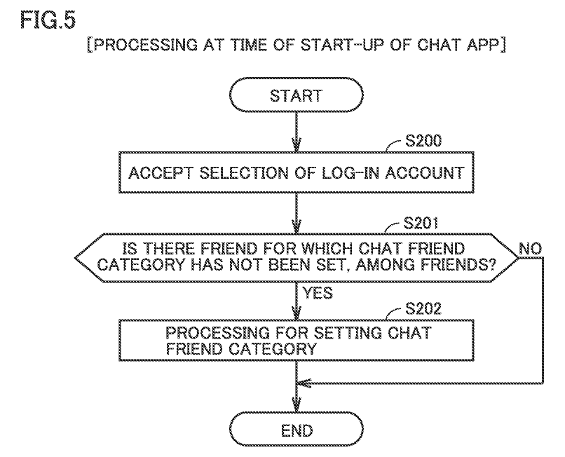

An exemplary flowchart showing processing at the time of start-up of a chat app will be described with reference to FIG. 5. Game terminal 30A realizes processing shown in FIG. 5 based on execution of communication application program 364.

Game terminal 30A accepts from the user, selection of a log-in account (step S200). In the present embodiment, account A is selected as the log-in account. Game terminal 30A determines whether or not there is a friend for which the chat friend category has not been set, among friends of the account that has logged in (step S201). A friend for which the chat friend category has not been set will be referred to as an "uncategorized friend" below.

When the chat friend category has been set for all friends of account A (NO in step S201), game terminal 30A quits the process. Timing of selection of the log-in account is not limited, and for example, the timing may be timing of start-up of game terminal 30A. For example, in an example where game terminal 30A is associated only with a single account, the account does not have to be selected in step S200.

When there is an uncategorized friend among friends of account A (YES in step S201), game terminal 30A performs setting processing for having the user set the chat friend category on the uncategorized friend (step S202). In other words, game terminal 30A has the user determine whether the uncategorized friend is to be set as the first-category account or the second-category account.

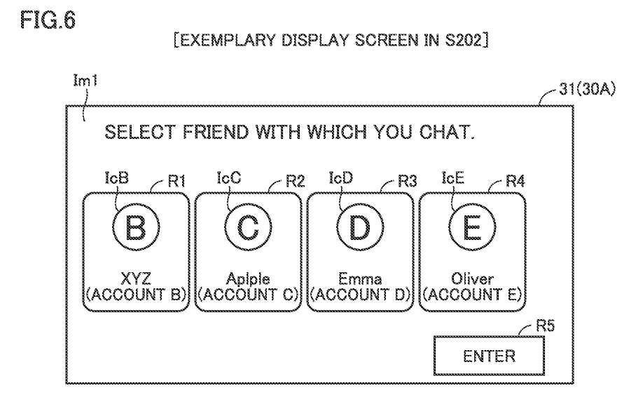

An exemplary display screen Im1 in step S202 will be described with reference to FIG. 6. Display screen Im1 is a screen shown on display 31 of game terminal 30A. Accounts B to E are shown on display screen Im1 as uncategorized friends of account A.

Information processing system 100 in the present embodiment has account A select a friend to be set as the second-category account on display screen Im1. By way of example, a message for selection of a friend with which the account will chat is shown in an upper part of display screen Im1 as shown in FIG. 6. Account A can select a plurality of uncategorized friends shown in display screen Im1.

Accounts B to E are shown within regions R1 to R4 included in display screen Im1 as the uncategorized friends, respectively. Regions R1 to R4 include icons IcB to IcE and account names of accounts B to E, respectively. Characters accounts B to E shown in parenthesis in FIG. 6 are for reference, and they do not have to actually be shown within display screen Im1.

Account A can select at least one region from among regions R1 to R4. Each of regions R1 to R4 may be shown, for example, in a color different between a state in which a region is selected by account A and a state in which the region is not selected, and when a region is selected, some kind of sign may be shown in the vicinity of the selected region.

A region R5 is a button for setting the selected account as the second-category account. In the present embodiment, account A selects region R5, for example, while it selects accounts B and C. Accounts B and C are thus set as the second-category accounts for account A. Accounts D and E not selected in display screen Im1, on the other hand, are set as the first-category accounts for account A in the present embodiment. In other words, these accounts D and E are set as the first-category accounts based on an operation to "set" accounts B and C "as the second-category accounts" by the user. Accounts D and E are set as the first-category accounts based on an operation to "select region R5 while they are not selected by the user."

In the present embodiment, these accounts D and E are set as the first-category accounts, with user's intention not to set accounts D and E as the second-category accounts being reflected. Region R5 may be, for example, a button for provisional decision, and a screen for confirming whether or not to set the selected account as the first-category account may be shown upon selection of region R5.

Information processing system 100 may have the user select an account to be set as the first-category account from among the uncategorized friends in display screen Im1, rather than having the user select an account to be set as the second-category account. Information processing system 100 may perform a function to collectively change the shown uncategorized friends to a selected state.

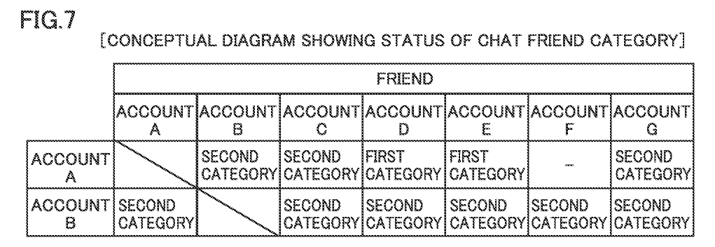

A status of the chat friend category will be described with reference to FIG. 7. FIG. 7 shows the chat friend category set by each of accounts A and B by way of example. As described with reference to FIG. 6, accounts B and C are set as the second-category accounts for account A and accounts D and E are set as the first-category accounts for account A. FIG. 7 further shows an example where friend relation is subsequently set between account A and each of accounts F and G. Account F is the uncategorized friend for account A, whereas account G is categorized as the second-category account for account A.

In the example shown in FIG. 7, account B is in friend relation with all of accounts A and C to G, and all friends are set as the second-category accounts for account B. The chat friend category is unidirectionally stored for each account. Information indicating the chat friend category of each account may be stored in server Sr1 as chat friend category information 166. A main key uniquely indicating information indicating the chat friend category may include identification information of an account and identification information of a friend associated with the account.

### [E. Overlay Notification]

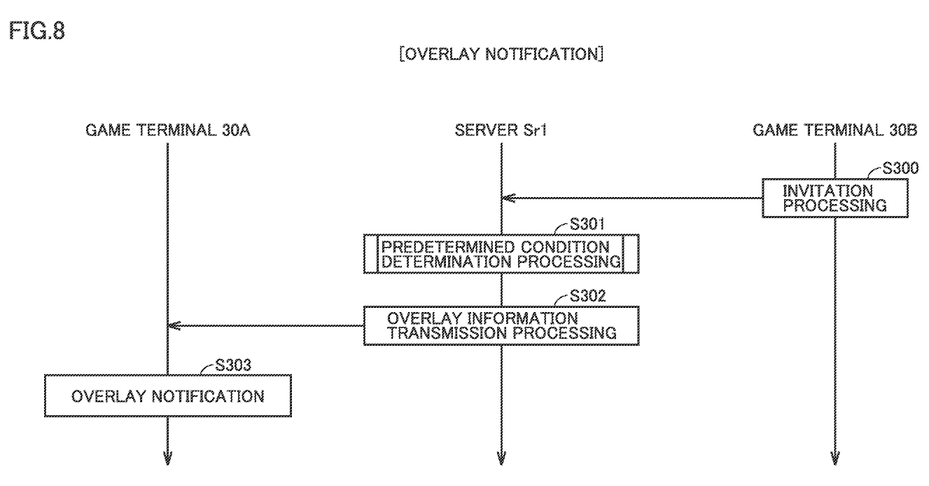

A flow of an overlay notification will be described with reference to FIG. 8. With the chat friend category shown in FIG. 7 being set, game terminal 30B accepts log-in by account B, and thereafter receives an instruction to invite a friend to a chat from the user of account B. The user of account B selects at least one account from among the friends for account B, as the account to be invited to the chat. An example in which account B selects accounts A, C, and F as accounts to be invited to the chat will be described below. In this example, account B is the host account and accounts A, C, and F are invited accounts.

Game terminal 30B performs invitation processing for transmitting information specifying the host account and the invited account(s) to server Sr1 (step S300). In the present embodiment, game terminal 30B transmits information for specifying account B itself which is the host account and information for specifying invited accounts A, C, and F to server Sr1. Server Sr1 that has accepted the invitation processing performs processing for determining a predetermined condition (step S301). In the present embodiment, server Sr1 performs determination processing for determining whether or not the predetermined condition is satisfied, on each of invited accounts A, C, and F, the predetermined condition including a condition that none of accounts that can participate in the virtual room is the first-category account for each invited account.

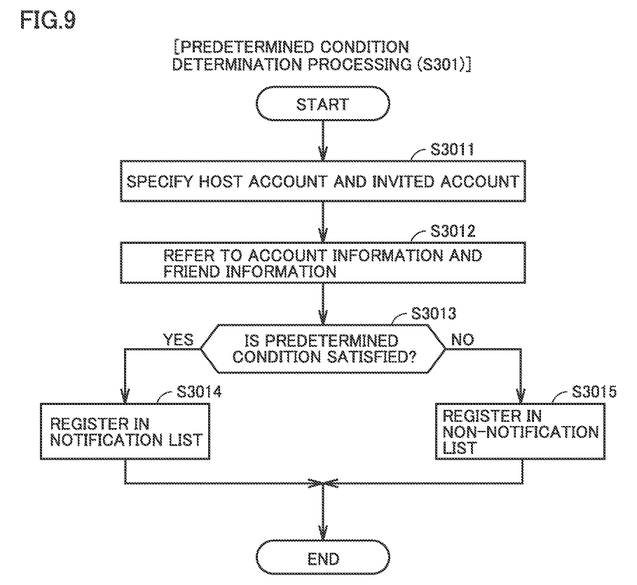

A flowchart for illustrating the determination processing in step S301 will be described with reference to FIG. 9. In step S301, server Sr1 performs the processing shown in FIG. 9. Server Sr1 specifies the host account and the invited account(s) with the use of account information 164, based on the invitation processing in step S300 (step S3011). In the present embodiment, server Sr1 specifies host account B and invited accounts A, C, and F.

Server Sr1 refers to account information 164, friend information 165, and chat friend category information 166 (step S3012). Server Sr1 thus specifies the friend relation set between the invited account and the host account and information on the chat friend category.

Server Sr1 determines whether or not the predetermined condition is satisfied for each invited account (step S3013). In the present embodiment, server Sr1 determines whether or not all accounts that can participate in the virtual room are the first-category accounts for each of invited accounts A, C, and F.

When none of the accounts that can participate in the virtual room is the first-category account for a certain invited account, server Sr1 determines that the predetermined condition is satisfied (YES in step S3013) and registers the certain invited account in a notification list (step S3014). With account A being defined as the certain invited account, with reference to FIG. 7, accounts B, C, and F are not the first-category accounts for account A. Therefore, server Sr1 adds account A to the notification list. The notification list is a list of accounts, of which overlay information is to be notified.

When at least one of all accounts that can participate in the virtual room is the first-category account for the certain invited account, server Sr1 determines that the predetermined condition is not satisfied (NO in step S3013), and registers the certain invited account in a non-notification list (step S3015). Server Sr1 may simply discard information on the certain invited account, without registering the certain invited account in the non-notification list.

Referring back to FIG. 8, server Sr1 performs processing for transmitting overlay information to the invited account registered in the notification list (step S302). Since at least account A has been registered in the notification list in the present embodiment, server Sr1 transmits the overlay information to game terminal 30A with which account A has been associated. The overlay information is information for causing game terminal 30A to give an overlay notification.

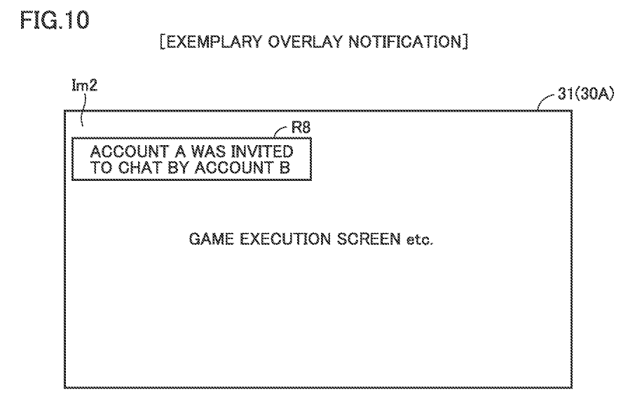

Game terminal 30A gives the overlay notification based on reception of the overlay information (step S303). A display screen Im2 showing an exemplary overlay notification will be described with reference to FIG. 10. Display screen Im2 includes a region R8 superimposed on a game execution screen or the like. In region R8, information indicating that account A is invited to a chat from account B is shown. Game terminal 30A may give another notification indicating an invitation to the chat, together with the overlay notification. Such an overlay notification may be shown whichever account has logged in to game terminal 30A or only when account A has logged in. When none of accounts has logged in to game terminal 30A, the overlay notification may or may not be shown.

If at least one of host account B and invited accounts C and F is the first-category account for account A or accounts D and E can participate in the virtual room, server Sr1 does not transmit the overlay information to game terminal 30A. Thus, when the first-category account for account A can participate in the virtual room, the overlay notification is not transmitted to game terminal 30A and game terminal 30A does not give the overlay notification.

Therefore, in information processing system 100, inadvertent participation of a certain account, for example, in the virtual room in which the first-category account for the certain account, with which the certain account does not assume to perform a chat, can participate can be suppressed. In addition, the user does not have to consider, for example, whether or not to participate in the virtual room in which an account, with which the user does not assume to perform a chat, can participate.

Server Sr1 does not have to perform the determination processing in step S301 but may generate and transmit the overlay information to all of game terminals 30 with which the invited accounts obtained in invitation processing have been associated. Server Sr1 may transmit to each game terminal 30, room information including information that specifies an account that can participate in the virtual room, together with the overlay information. Each game terminal 30 may determine whether or not the first-category account for the each game terminal can participate in the virtual room based on the received room information and may give the overlay notification in accordance with a result of determination. In other words, game terminal 30A rather than server Sr1 may perform processing for determining whether or not the predetermined condition is satisfied.

In the present embodiment, an entity to perform determination processing for determining whether or not the predetermined condition is satisfied is server Sr1, and when the predetermined condition is not satisfied, the overlay information is not generated and transmitted. Therefore, an amount of processing by server Sr1 and an amount of communication between server Sr1 and game terminal 30 can be reduced.

The predetermined condition may include a condition other than the condition that the first-category account is not included in accounts that can participate. In the present embodiment, the predetermined condition includes a condition that a blocked account blocked by the invited account cannot participate in the virtual room. The blocked account is an account selected by the user, and it is an account on which such restriction as non-permission to execute a communication game together with the user or non-permission to apply for a friend to the user is imposed, by way of example. The blocked account may or may not be in friend relation with the user.

### [F. Display of Room in List]

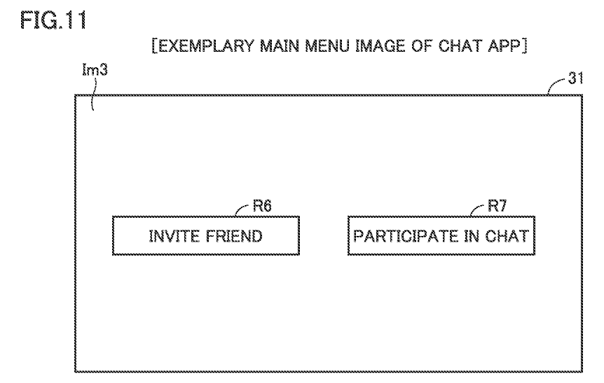

Display in a list, of a room to which an account is invited will be described below. An invited account may be invited by a plurality of different host accounts, and in this case, the invited account can participate in a plurality of rooms. The user of the invited account can view display of rooms in a list which will be described below and then select in which room the user participates. An exemplary main menu screen Im3 of a chat app will be described with reference to FIG. 11. Main menu screen Im3 may be shown, for example, after the flowchart in FIG. 5 is executed.

Main menu screen Im3 includes regions R6 and R7. Region R6 is a button for inviting a friend to a chat, with an account that has logged in being defined as the host account. In the present embodiment, upon selection of region R6, a list of second-category accounts for the account that has logged in may be shown.

Region R7 is a button for participation in the virtual room to which the invited account is currently being invited by another host account, with the account that has logged in being defined as the invited account. In the present embodiment, upon selection of region R7, rooms to which the account that has logged in is being invited and in which the first-category account for the account that has logged in cannot participate are shown in a list.

In other words, game terminal 30 does not show the virtual room in which the first-category account can participate, in a room list shown on display 31 after selection of region R7. The virtual room in which the first-category account cannot participate, the virtual room being shown as a room list after selection of region R7, is referred to as a "shown room," and the virtual room not shown in the room list after selection of region R7 because the first-category account can participate therein is referred to as a "not-shown room." In the present embodiment, game terminal 30 shows a list of not-shown rooms when it accepts a predetermined operation different from selection of region R7 from the user.

A condition to be the not-shown room may include a condition other than the condition that the first-category account is included in accounts that can participate in, similarly to the overlay notification. In the present embodiment, the condition to be the not-shown room includes a condition that a blocked account blocked by the invited account can participate in the virtual room.

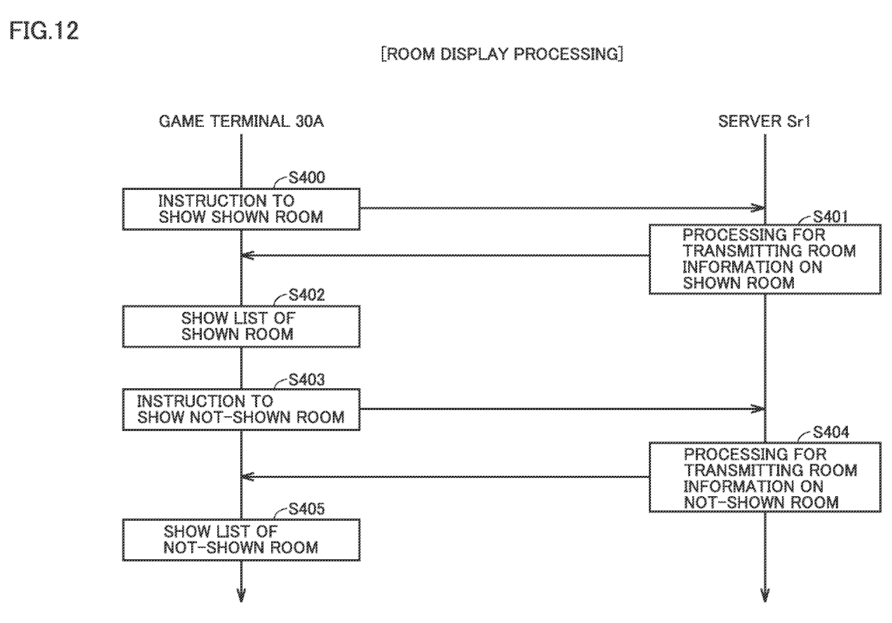

An exemplary sequence diagram for showing a list of virtual rooms will be described with reference to FIG. 12. Display of a list of shown rooms and not-shown rooms will be described with reference to game terminal 30A and account A, by referring to FIG. 12 and following figures. Game terminal 30A accepts an instruction to show the shown room from the user upon selection of region R7 by the user of account A and transmits information indicating acceptance of the instruction to server Sr1 (step S400).

Server Sr1 determines whether or not an account which is a transmitter of the instruction to show the shown room has been invited to the virtual room by another host account. When the account has been invited to the virtual room, server Sr1 transmits to game terminal 30, room information on all virtual rooms (shown rooms) in which the first-category account for the account which is the transmitter of the instruction cannot participate among the virtual rooms to which the account has been invited (step S401). Game terminal 30A shows a list of shown rooms in which the first-category account cannot participate, the list being received from server Sr1 (step S402).

Game terminal 30A may then accept an instruction to show the not-shown room from the user by receiving a predetermined operation (step S403). Server Sr1 transmits room information on the virtual room (not-shown room) in which the first-category account can participate, based on acceptance of the instruction to show the not-shown room (step S404). Game terminal 30A shows a list of not-shown rooms based on the room information on the not-shown room received from server Sr1 (step S405).

In the example in FIG. 11, in step S401 and step S404 for each virtual room, server Sr1 performs determination processing for determining whether or not the predetermined condition described with reference to step S3013 in FIG. 9 is satisfied. In accordance with the result of the determination processing, in step S401, server Sr1 transmits the room information on the virtual room in which the first-category account cannot participate, and in step S404, transmits the room information on the virtual room in which the first-category account can participate.

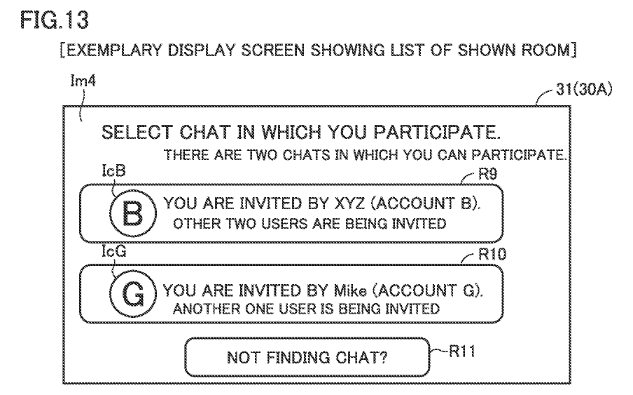

An exemplary display screen Im4 showing a list of shown rooms will be described with reference to FIG. 13. An example in which account A is invited to four virtual rooms will be described in FIG. 13 and following figures. A first room is a room to which accounts A, C, and F are invited by host account B. As shown in FIG. 7, account F is an uncategorized friend for account A. A second room is a room to which accounts A and B are invited by account G.

A third room is a room to which accounts A and B are invited by account D. A fourth room is a room to which account A and an account blocked by account A are invited by account C.

Since neither of the first room and the second room is the room in which the first-category account for account A can participate, the first room and the second room are shown rooms. The third room, on the other hand, is a room in which the first-category account (account D) for account A can participate, and hence it is the not-shown room. Furthermore, since the fourth room is a room in which the blocked account for account A can participate, it is the not-shown room.

FIG. 13 shows, as a list of rooms in which the first-category account for account A cannot participate, two rooms which are the room to which account A is invited by account B and the room to which account A is invited by account G. Display screen Im4 in FIG. 13 may be shown, for example, upon selection of region R7 in main menu screen Im3 by the user of account A. Regions R9 and R10 show the virtual rooms to which account A is invited by accounts B and G, respectively.

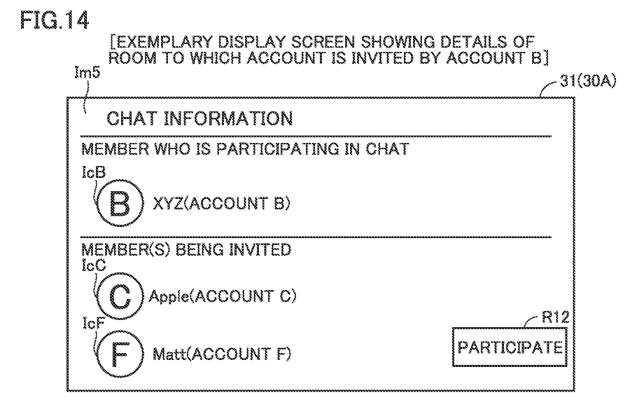

None of accounts B, C, F, and G that can participate in the first room and the second room is the first-category account for account A. Therefore, the two virtual rooms to which account A is invited by host accounts B and G are shown as the shown rooms in the room list on display screen Im4 as shown in FIG. 13. Thus, the not-shown rooms described above are not shown in display screen Im4 showing the list of shown rooms. Upon selection of region R9 or R10, game terminal 30A shows information on each corresponding room. FIG. 14 shows an exemplary display screen on display 31 when region R9 is selected.

An exemplary display screen Im5 showing details of the virtual room to which account A is invited by account B will be described with reference to FIG. 14. The user of account A can know information on the shown room from display screen Im5. On display screen Im5, a member that is participating in a chat and a member being invited to the chat are shown. The member that is participating in the chat indicates an account that is currently participating in the chat, and the invited member indicates at least one of an account that has been invited but has not yet entered the virtual room and an account that has already left the virtual room. In the example in FIG. 14, the user of account A can know that account B is participating in the virtual room and accounts C and F can participate in the room but they have not yet entered the virtual room. On display screen Im5, the fact that the chat friend category for account F has not yet been set may be shown to account A.

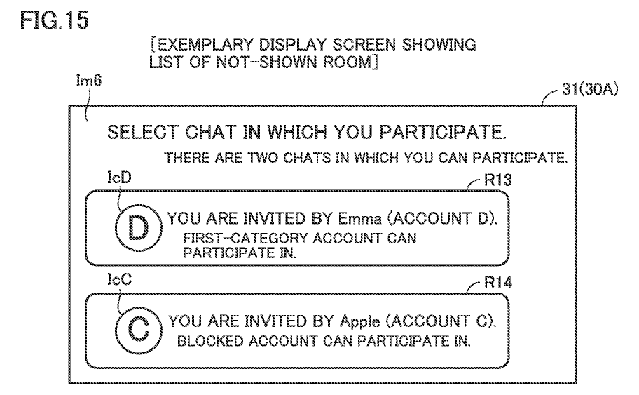

A technique to show the not-shown room will then be described. Information processing system 100 in the present embodiment can show a list of not-shown rooms upon selection of a region R11 in FIG. 13. Region R11 is a button for showing the not-shown room. Upon selection of region R11 in display screen Im4, the display screen of display 31 makes transition to FIG. 15. Selection of region R11 may correspond to step S403 in FIG. 12.

An exemplary display screen Im6 showing a list of not-shown rooms will be described with reference to FIG. 15. Display screen Im6 includes regions R13 and R14. Regions R13 and R14 indicate the third room and the fourth room to which account A is invited by accounts D and C, respectively. The third room is a room in which account D that is the first-category account for account A can participate as the host, and hence it is the not-shown room. The fourth room is a room in which the account set by account A as the blocked account can participate, and hence it is the not-shown room.

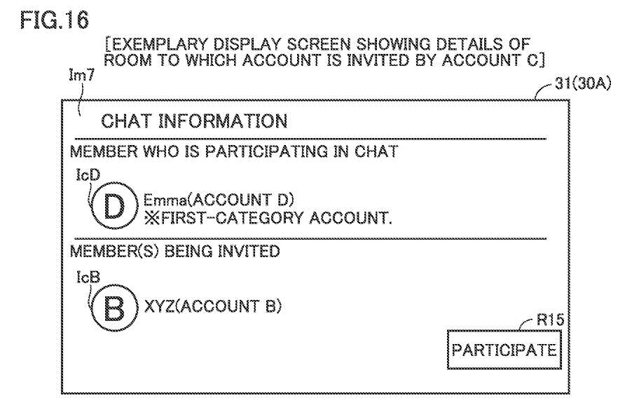

Upon selection of region R13, the display screen of display 31 makes transition to FIG. 16. An exemplary display screen Im7 showing details of the virtual room to which account A is invited by account D will be described with reference to FIG. 16. As shown in FIG. 16, account D set as the first-category account by account A is participating in the third room. On display screen Im7, the fact that account D is the first-category account is shown. The user of account A can thus know the reason why the third room is the not-shown room, by watching display screen Im7. Even if the host of the third room is account B and accounts A and D are invited to the third room, the third room is the not-shown room because account D set as the first-category account can participate in the third room. Account A can participate in the third room by selection of a region R15.

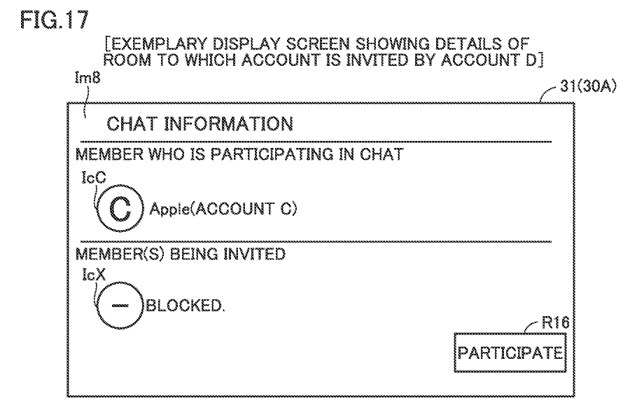

An exemplary display screen Im8 showing details of the virtual room to which account A is invited by account C will be described with reference to FIG. 17. As shown in FIG. 17, an account set as the blocked account by account A has been invited to the fourth room. The user of account A can thus know the reason why the fourth room is the not-shown room, by watching display screen Im8. On display screen Im8 showing details of the room shown in FIG. 17, information (an account name, an icon, or the like) for identification of the blocked account is not shown. An icon IcX is a general-purpose icon indicating the blocked account.

Thus, in information processing system 100, while recall by account A, of information on the blocked account is suppressed, the fact that the blocked account is invited can be suggested to account A. In an example where the blocked account has been invited to the virtual room, account A may be unable to participate in the virtual room in spite of selection of a region R16. In this case, region R16 may be shown in such a manner that it is recognizable as being inactive as the button.

### [G. Modification]

Other forms which are partial modification of the embodiment described above will be described below.

Each of processors 14 and 34 may be implemented by a single chip or a plurality of chips. Each of processors 14 and 34 and associated processing circuitry may be implemented by a plurality of computers connected to one another through a wire or wirelessly over a local area network, a wireless network, or the like. The processor and the associated processing circuitry may be implemented by such a cloud computer as performing remote computation based on input data and outputting a result of computation to another device located at a distant location.

In the example in FIG. 1, server Sr1 and game terminal 30 are each shown as a single apparatus. Server Sr1, however, may be implemented as an assembly of a plurality of apparatuses. For example, server Sr1 may include a plurality of servers. Similarly, game terminal 30 may also be implemented as an assembly of a plurality of apparatuses. For example, game terminal 30 may include a separate configuration including a main body portion including at least a processor, a controller portion including at least a user-operable portion, and a display portion including at least a display.

Though account information 164, friend information 165, and chat friend category information 166 are described as being stored in storage 16 of server Sr1 with reference to FIG. 2, at least some of such information may be held by an external server other than server Sr1 or game terminal 30.

The second-category account may be, for example, a "favorite friend." The favorite friend may be shown, for example, at a high level in a shown list of friends. Setting of the favorite friend separately from the second-category account may be allowed.

Though only the second-category account for the host account is shown as a candidate for an account to be invited in selection of a friend to be invited to the virtual room by the host account, accounts including also the first-category account may also be shown. Whether an account is the first-category account or the second-category account may be irrelevant to display as the candidate for the account to be invited. For example, as a result of a specific operation by the user while only the second-category account is shown as the candidate for the account to be invited, accounts including also the first-category account or the first-category account may be shown.

An example in which, when the first-category account cannot participate in the virtual room, both of the overlay notification and display in a list of shown rooms shown in FIG. 13 are performed is described above. When the first-category account cannot participate in the virtual room, however, only at least one of the overlay notification and display in the list of shown rooms shown in FIG. 13 may be performed. For example, in information processing system 100, the overlay notification is not given for the virtual room in which the first-category account can participate, whereas the virtual room may be included in the list of shown rooms shown in FIG. 13.

The friend category in connection with the chat may include a third category in addition to the first category and the second category. By way of example, when a certain invited account is invited to the virtual room in which a third category account for the certain invited account can participate, information processing system 100 does not give the overlay notification to the certain invited account but may incorporate the virtual room in the list of shown rooms. In another example, the third category account may be a friend with which the user desires to positively chat. For example, the third category account may be an account for which a notification that the third category account is ready to be invited to the chat is given.

In the example described above, by the overlay notification to game terminal 30, the user is notified that the user is invited to the virtual room. The overlay notification is by way of example, and for example, a notification image not overlaid on an image of a game being executed may be shown on the display. Alternatively, when there is a virtual room to which an account is invited, a manner of display of an icon indicating a chat application or surroundings thereof may be varied. Furthermore, instead of or in addition to the image, a notification may be given by other means. For example, a notification of an invitation may be given by notification sound, voice guidance, vibration, or the like. Combination of these notification techniques may notify the user that the user is invited to the virtual room.

Though an example of data transmission/reception between game terminals 30 shown in FIG. 8 via server Sr1 in information processing system 100 is described, data may directly be transmitted/received between game terminals 30.

Though the predetermined condition includes a condition that the blocked account cannot participate in the virtual room in the example described above, the predetermined condition does not have to include that condition. Similarly, though a condition to be the not-shown room includes a condition that the blocked account can participate in the virtual room, it does not have to include that condition. Information processing system 100 may be unable to set the blocked account as a status of an account.

In the example described above, whether or not the uncategorized friend can participate in the virtual room is irrelevant to whether or not the overlay notification is given. The predetermined condition may include a condition that the uncategorized friend cannot participate in the virtual room. For example, the predetermined condition may include a condition that neither of the first-category account and the uncategorized friend can participate.

Whether or not an account which is not a friend can participate in the virtual room may be irrelevant to whether or not the overlay notification is given. In contrast, the predetermined condition may include a condition that an account which is not a friend cannot participate in the virtual room.

In the example described above, as described with reference to FIG. 6, the user is described as categorizing a friend to an uncategorized friend at the time of start-up of the chat app. Information processing system 100 may be able to categorize a friend to an uncategorized friend in advance at the time of application for a friend. For example, in a stage of application (S101) for a friend described with reference to FIG. 4, account A may perform an advance setting operation at the time of permission to be in friend relation by account B, the advance setting operation being an operation to set in advance, as which of the first-category account and the second-category account, account B is to be set. Similarly, in a stage of permission (S103) as a friend described with reference to FIG. 4, account B may be able to set as which of the first-category account and the second-category account, account A is to be set.

FIG. 12 illustrates that server Sr1 performs in steps S401 and S404, determination processing for determining whether or not the predetermined condition is satisfied. Server Sr1, however, may transmit to game terminal 30A, room information on all virtual rooms to which account A is invited, at the time of reception of the instruction to show the room list, without performing the determination processing. In this case, game terminal 30A may perform the determination processing for determining whether or not the predetermined condition is satisfied for the room information on each of all virtual rooms to which account A is invited. Game terminal 30A may thus show in a list, the room information on the virtual room determined by game terminal 30A itself, in response to an instruction to show the list of shown rooms and the list of not-shown rooms from the user of account A.

Though the example above describes association of an account with game terminal 30, the account may be associated also with another terminal such as a smartphone, in addition to game terminal 30. For example, an account may be associated with a predetermined application installed in a smartphone, and when the account is invited to the virtual room, a notification may be given to the application (or the smartphone) as in the case of the overlay notification described above. Such a notification to a terminal other than game terminal 30 may be given together with the overlay notification to game terminal 30, or only at least one of them may be given.

In the example described above, in step S300 in FIG. 8, an account selected by the host account is invited as the invited account. After the host account generates the virtual room and invites the invited account, it may be able to change the invited account. The invited account may be able to invite another account.

Though the example above describes that the not-shown room is shown upon selection of region R11, the not-shown room may be shown by another operation. The not-shown room, on the other hand, may be a room that cannot be displayed by any operation.

Though the example above describes that, by selection of region R15, account A can participate in the not-shown room to which account A is invited by account C, an account may be unable to participate in the virtual room in which the first-category account can participate, similarly to the example where the blocked account is invited. In this case, the account can participate in the virtual room by setting again by the user, of the account that has been set as the first-category account to the second-category account.

Though region R11 is shown in display screen Im4 showing the room list of shown rooms in the example described above, region R11 may be shown in another screen such as the setting screen or a screen for management of an account.

Though an account immediately after setting of friend relation thereof is described as being set as the uncategorized friend in the example described above, it may automatically be set to at least one of the first-category account and the second-category account by default.

Though an example in which, in steps S3013 and 3014 described above, the invited account is registered in the notification list when the predetermined condition is satisfied, and in step S302, the overlay information is collectively transmitted to the registered invited accounts is described above, server Sr1 may transmit the overlay information to a corresponding invited account each time the predetermined condition is satisfied.

In information processing system 100, a supervised account and a supervisor account that supervises the supervised account may be set. The supervised account may be able to chat only with a friend permitted by the supervisor account among its friends. In this case, the supervised account may or may not be notified of an invitation to the virtual room where a friend with which the supervised account is not permitted to perform a chat is included. A friend of the supervised account may not be set as the first-category account or the second-category account. This is because, as described above, for performing a chat, permission by the supervisor account is required, and intention of the supervised account that the supervised account has asked the supervisor account for permission is reflected on the friend with which the supervised account is permitted to perform the chat. A friend of the supervised account may also be set as the first-category account or the second-category account.

The account that left the virtual room may be handled as not being an account that can participate. The account that once left the virtual room may not be permitted to participate again in the room which it left. When the invited account invited to the virtual room declines the invitation, the invited account may not be handled as an account that can participate in the virtual room.

Though a friend is described above as being categorized to one of the first-category account and the second-category account by the user, categorization to the first-category account and the second-category account may be determined not only by selection by the user but also based on another condition.

FIG. 5 illustrates that, when there is an uncategorized friend at the time of start-up of the chat app (YES in step S201), processing for setting the chat friend category is performed (step S202). Timing of processing in steps S201 and S202 does not have to be timing of start-up of the chat app, but may be, for example, timing of an attempt by the user to participate in the room in which the uncategorized friend can participate.

Though the example in FIG. 10 illustrates that information indicating that account A is invited to a chat by host account B is shown in region R8, region R8 does not have to include information indicating which account serves as the host account. In addition to text "account A" included in region R8, an icon IcA indicating account A may be shown, or icon IcA may be shown instead of the text "account A."

Setting for a certain account, of another account as the second-category account may be hidden from that another account. This is also applicable to the first-category account.

Though the first-category account and the second-category account are unidirectionally set in the example above, they may bidirectionally be set.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A system comprising:
at least one memory storing instructions that, when executed, cause at least one computer of the system to perform operations comprising performing a voice chat between terminals used by a plurality of respective accounts that participate in one room, setting, based on an operation by a user of a first account, one or more accounts in friend relation with the first account as first-state accounts for the first account, determining whether a predetermined condition is satisfied when an invitation operation to invite the first account to a room is performed by a user of a second account, the predetermined condition comprising a condition that at least one of the first-state accounts for the first account is not participating in the room, and causing a terminal used by the first account to notify that the first account is invited to the room when the predetermined condition is satisfied.

2. The system according to claim 1, wherein
the operations comprise showing, at the terminal used by the first account, a room that satisfies the predetermined condition, in a room list where at least one room to which the first account is invited by another account is shown in a list.

3. The system according to claim 2, wherein the operations comprise obtaining, at the terminal used by the first account, information on the room to which the first account is invited, and showing, at the terminal used by the first account, in the room list, the room that satisfies the predetermined condition among at least one room corresponding to the obtained information.

4. The system according to claim 2, wherein
the operations comprise showing, at the terminal used by the first account, a room not satisfying the predetermined condition, when a predetermined operation is accepted from the user of the first account while the room list is shown.

5. The system according to claim 2, wherein the operations comprise obtaining, at the terminal used by the first account, information on a room that satisfies the predetermined condition, showing, at the terminal used by the first account, information that satisfies the predetermined condition, in the room list, obtaining, at the terminal used by the first account, information on a room that does not satisfy the predetermined condition when a predetermined operation is accepted from the user of the first account, and showing, at the terminal used by the first account, information that does not satisfy the predetermined condition, in the room list.

6. The system according to claim 1, wherein the operations comprise obtaining, at the terminal used by the first account, information indicating an invitation to a chat when the predetermined condition is satisfied.

7. The system according to claim 1, wherein the predetermined condition comprises a condition that a blocked account for the first account is not participating in the room.

8. The system according to claim 1, wherein the operations further comprise setting a third account as the first-state account for the first account, when the third account approves a friend application to be in the friend relation, in accordance with an advance setting operation in transmission of the friend application by the first account to the third account.

9. The system according to claim 1, wherein the operations further comprise setting, among the one or more accounts in the friend relation with the first account, an account different from the first-state account as a second-state account shown as a candidate for an account to be invited by the first account to the room, based on an operation by the user of the first account.

10. The system according to claim 9, wherein the operations further comprise causing the user to select an account to be the second-state account from among the one or more accounts in the friend relation and setting an account that has not been selected as the first-state account.

11. The system according to claim 9, wherein the operations further comprise notifying, when the predetermined condition is satisfied, the user that the first account is invited to the room independently of whether a friend that is neither of the first-state account and the second-state account for the first account is participating in the room.

12. The system according to claim 1, wherein the predetermined condition comprises a condition that the first-state account is not scheduled to participate.

13. A non-transitory computer-readable storage medium storing executable instructions that, when executed, cause at least one computer to execute operations, the operations comprising:
performing a voice chat between terminals used by a plurality of respective accounts that participate in one room, setting, based on an operation by a user of a first account, one or more accounts in friend relation with the first account as first-state accounts for the first account, determining whether a predetermined condition is satisfied when an invitation operation to invite the first account to a room is performed by a user of a second account, the predetermined condition comprising a condition that at least one of the first-state accounts for the first account is not participating in the room, and causing a terminal used by the first account to notify that the first account is invited to the room when the predetermined condition is satisfied.

14. A method comprising:
performing a voice chat between terminals used by a plurality of respective accounts that participate in one room, setting, based on an operation by a user of a first account, one or more accounts in friend relation with the first account as first-state accounts for the first account determining whether a predetermined condition is satisfied when an invitation operation to invite the first account to a room is performed by a user of a second account, the predetermined condition comprising a condition that at least one of the first-state accounts for the first account is not participating in the room, and causing a terminal used by the first account to notify that the first account is invited to the room when the predetermined condition is satisfied.
